(19) United States
(12) Patent Application Publication
(10) Pub. No.: US 2013/0293021 A1
(43) Pub. Date: Nov. 7, 2013

(54) ENHANCED UTILIZATION OF REAL POWER GENERATING CAPACITY OF DISTRIBUTED GENERATOR (DG) INVERTERS AS STATCOM

(71) Applicants: Rajiv Kumar VARMA, London (CA); Vinay SHARMA, London (CA)

(72) Inventors: Rajiv Kumar VARMA, London (CA); Vinay SHARMA, London (CA)

(21) Appl. No.: 13/875,014

(22) Filed: May 1, 2013

Related U.S. Application Data
(60) Provisional application No. 61/641,245, filed on May 1, 2012.

(51) Int. Cl. H02J 3/18

(52) U.S. Cl. CPC H02J 3/18
USPC 307/75

(57) ABSTRACT

Systems, methods, and devices relating to the provision of system control support in the form of reactive power support or voltage control support to power transmission or distribution networks using inverter based power generation facilities that are coupled to the power transmission or distribution networks. An inverter based power generation facility, such as a photovoltaic based solar farm or a wind farm, can task all or a portion of its inverter capacity to provide reactive power support or voltage control support to the power transmission or distribution network. This invention applies to the operation of PV solar systems anytime during the day (even during peak power generation times) and other inverter based DGs during the entire 24-hour period. The power generation facility disconnects at least one of its power generation modules from the power transmission or distribution network and makes available required inverter capacity for providing system control support.

### TECHNICAL FIELD

The present invention relates to inverter based distributed power generation facilities. More specifically, the present invention relates to providing reactive power support or voltage control support to power transmission and distribution systems using inverter based distributed generators (DG) even during times when the generator is producing real power.

### BACKGROUND OF THE INVENTION

Power transmission and distribution systems are commonly subject to disturbances, such as faults, equipment failure, loss of lines, transformers, etc. Such disturbances could result in overloading of lines, which could potentially lead to line trippings, load shedding, system instability or blackouts. The faults could potentially lead to shutdown of power for manufacturing plants. In some instances, some of these processes are time sensitive and cannot be interrupted—interruption can cause the process to fail thereby wasting valuable resources. For processes involving volatile and potentially dangerous chemicals, interrupting the process may require that intermediate products be destroyed. For processes that involve massive industrial complexes, interrupting the process will result in losses costing millions of dollars. The system operators make every effort to avoid collapse of voltages or excursions of voltage beyond acceptable limits. During these events, the system operator needs large reactive power support from various operating generators. This reactive power support is typically of a fixed amount, which may be large. System operators (such as, Independent Electricity System Operator—IESO of Ontario) need generators to operate in a dispatchable mode to provide much needed reactive power support at critical locations in the electrical network to ensure stable, secure and continual power supply in the grid.

Some power system fault scenarios can result in voltage fluctuations beyond acceptable limits, which could cause power equipment to maloperate and to shutdown critical induction motor loads, for instance. Power utility companies therefore seek to prevent such events from occurring or they seek techniques for controlling voltages by different reactive power devices. Ideal amongst these devices are those which can provide dynamically controllable reactive power (leading or lagging).

Currently, some power utility companies use STATCOMs (static synchronous compensator) to provide reactive power or voltage support to their power transmission networks. STATCOMs can act as a source or a sink of reactive power for the power transmission and distribution network and can assist in reactive power compensation as well as in voltage regulation for the power transmission and distribution network. More technically, a static synchronous compensator (STATCOM) is a shunt connected reactive power compensation device capable of generating and/or absorbing reactive power and whose output can be varied to control specific parameters of an electrical power system. In general terms, a STATCOM is a solid-state switching converter that is capable of independently generating or absorbing controllable real and reactive power at its output terminals when it is fed from an energy source or an energy storage device at its input terminals.

More specifically, the STATCOM is a voltage source converter that produces from a given input of direct current (DC) voltage a set of three-phase AC output voltages. Each output voltage is in phase with and is coupled to the corresponding AC system voltage through a relatively small reactance (which can be provided either by an interface reactor or leakage inductance of a coupling transformer). The DC voltage is provided by an energy storage capacitor.

It is also known that a STATCOM provides desired reactive power generation, as well as reactive power absorption, by means of electronic processing of voltage and current waveforms in a voltage source converter (VSC). The STATCOM also provides voltage support by generating or absorbing reactive power at the point of common coupling (PCC) without the need for large external reactors or capacitor banks. Therefore, the STATCOM occupies a much smaller physical footprint.

While installed STATCOMs can alleviate reactive power and voltage regulation issues in existing power transmission and distribution networks, the currently installed base of STATCOMs can be quite expensive and, as such, power utility companies are hesitant to install further STATCOMs for voltage control support unless it is shown to be cost-effective.

Based on the above, there is therefore a need for methods and devices that overcome or at least mitigate the issues with the prior art.

### SUMMARY OF INVENTION

The present invention provides systems, methods, and devices relating to the provision of reactive power support and voltage control support in power transmission and distribution networks using inverter based power generation facilities that are coupled to the power transmission and distribution networks. An inverter based power generation facility, such as a photovoltaic based solar farm or a wind farm, can task all of its inverter capacity to provide reactive power support or voltage control support to the power transmission and distribution network. This can be done anytime during the daytime operation of PV solar systems (even during peak power generation times) and during the entire 24-hour period for other inverter based DGs.

To provide reactive power support or voltage control support, the power generation facility disconnects its power generation modules from the power transmission and distribution network and may instead couple inductor or capacitor banks to increase, decrease, or adjust the reactive power or the voltage sensed at the point of common coupling where the power generation facility couples to the power transmission and distribution network. Based on the required reactive power support or voltage control support, the power generation facility can provide fixed or controllable reactive power, as needed by the power transmission and distribution network, for a predetermined amount of time. The power generation facility thereby acts as a STATCOM for that predetermined amount of time and the operator of the facility can charge the power utility company accordingly for the use of his or her facility as a STATCOM.

In a first aspect, the present invention provides a method for providing fixed reactive power support or voltage control support (through dynamically controlled exchange of reactive power) to a power transmission and distribution network using an inverter based power generation facility, the method comprising:
a) determining that reactive power support or voltage control support is required by said power transmission or distribution network;
b) determining power conditions on said power transmission or distribution network;
c) determining the amount of fixed reactive power support or the amount of voltage control support required based on said power conditions;
d) altering a function of said power generation facility from real power production to provision of reactive power support or voltage control support; and
e) utilizing at least a portion of said power generation facility's inverter capacity to provide said reactive power support or voltage control support.

In a second aspect, the present invention provides a method of generating income for an inverter based power generation facility, the method comprising:
a) receiving an indication that reactive power support or voltage control support is required by a power transmission or distribution network;
b) altering a function of said power generation facility from real power production to provision of reactive power support or voltage control support;
c) providing said fixed amount of reactive power support or voltage control support to said power transmission or distribution network for a predetermined amount of time using at least a portion of said power generation facility's inverter capacity;
d) charging an operator of said power transmission and distribution network for said provision of fixed reactive power support or voltage control support to said power transmission or distribution network.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of a representative environment on which the invention may be practiced;

FIG. 2 is a detailed PV solar farm schematic illustrating the features in conventional solar farm circuitry;

FIG. 3 is a circuit diagram illustrating the circuitry at a PV solar farm according to one implementation of the invention;

FIG. 4 is a flowchart detailing the steps of the operation of the auxiliary controller illustrated as part of FIG. 3; and

FIG. 5 is a flowchart detailing the steps in a further aspect of the invention.

### DETAILED DESCRIPTION OF THE INVENTION

The present invention relates to a new control of inverter based Distributed Generators (DG) to perform as a Static Synchronous Compensator—STATCOM, utilizing the inverter capacity required for producing real power. Through the inventive control, the inverter based Distributed Generators will curtail their real power production in response to a call/signal from the power system operator for a specified period of time, and transform to a STATCOM for providing a fixed amount of reactive power support or controlled reactive power for voltage control with the power system as directed by the system operator. The time duration for which the inverter based DGs will be required to limit their real power production will be determined by the needs of the power system. This implies a loss of revenue for the inverter based DGs for the time duration they are instructed to stop producing real power fully or partially. However, the financial benefit or loss avoidance for the overall power system will be substantially greater compared to the cost of real power curtailed. The inverter based DGs will not only be compensated for the loss of revenue from sale of real power that they would forgo producing in that period, but would also be eligible to receive a share of the profit/benefit incurred by the system operator or any other beneficiary as a result of the reactive power support or voltage support provided by the inverter based DGs. This invention applies to the operation of PV solar systems during daytime and other inverter based DGs during the entire 24-hour period.

The proposed novel DG controls will also impart a new capability to inverter based DGs to function as a dispatchable reactive power source. In other words, this proposed control will turn a static (inverter based) DG system into an inertia-less synchronous generator. The inverter based DG will thus transform from a “Real Power P” generator to a combination of a “P” generator and a STATCOM providing controllable “Reactive Power Q”. In case of a PV solar system, even during daytime when the sun is shining, this controller can alter a PV generator into a system capable of providing a continuous spectrum of 100% real power P (kW) to 100% reactive power Q (VAr).

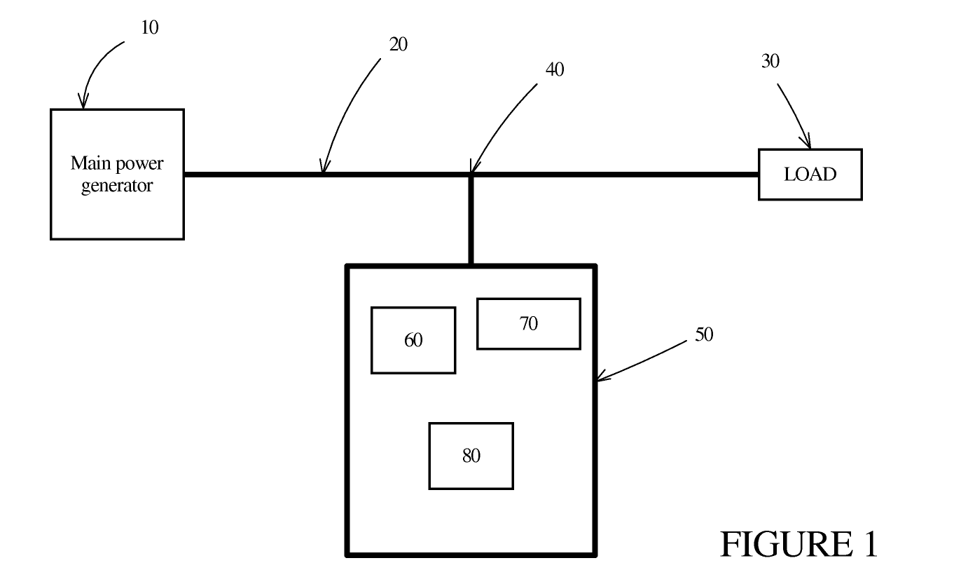

Referring to FIG. 1, a block diagram of the environment surrounding the invention is illustrated. A main power generation facility 10 is coupled to a power transmission or distribution network 20. At the other end of the power transmission or distribution network 20 is a load 30. The load 30 may be a separate power system, or an industrial complex with a variety of devices which may include induction motors. Also coupled to the power transmission network 20 at a common coupling point 40 is an inverter based power generation facility 50. The power generation facility 50 is equipped with power generation modules 60, a controller 70, and an auxiliary controller 80.

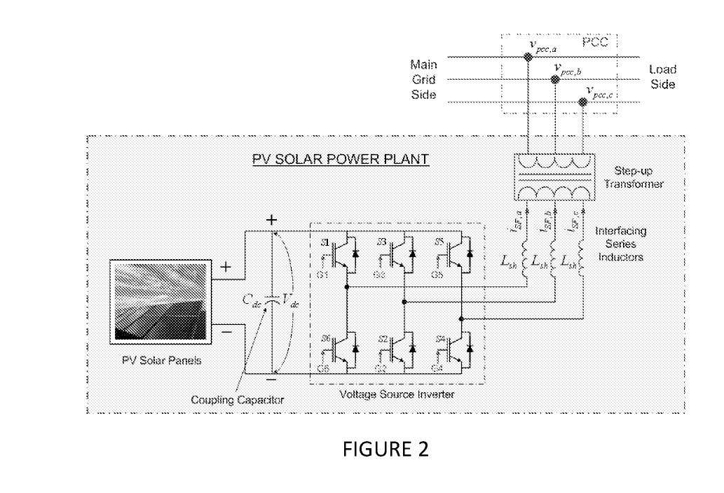

FIG. 2 is a detailed PV solar farm schematic, modeled as a voltage source inverter with a DC bus capacitor. The voltage source inverter is realized by utilizing six semiconductor switches (here, Insulated Gate Bipolar Transistors (IGBTs)). It may be understood that there are several types/configurations of voltage source converters/inverters. However, the invention applies to any type/configuration of the inverter. The inverter is connected to the network through interfacing series inductors and a step-up transformer. The point at which the PV solar farm is connected to the power transmission network is termed as the point of common coupling (PCC). The currents injected/delivered by the PV solar farm are denoted as i_{SF,a}, i_{SF,b} and i_{SF,c}.

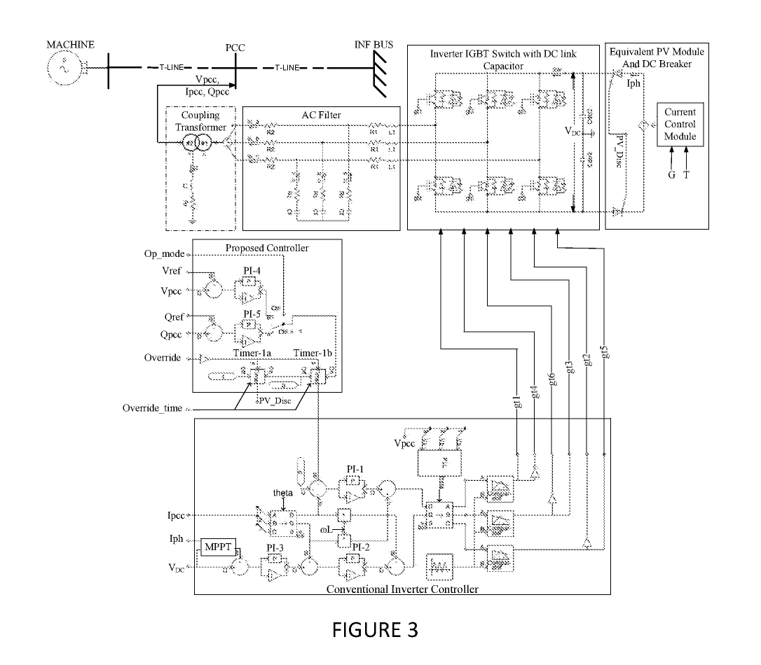

Referring to FIG. 3, a block diagram of a PV solar farm circuitry according to one aspect of the invention is illustrated. As can be seen, the PV solar farm circuitry in FIG. 3 includes an auxiliary controller (labelled as “Proposed Controller” in the Figure) that interfaces with a conventional inverter controller. The auxiliary controller in FIG. 3 is used for reactive power support or voltage control support and can be operated to provide a fixed amount of reactive power or controllable reactive power for voltage regulation or voltage maintenance mode. To operate in reactive power support mode, which exchanges (injects or absorbs) reactive power at PCC, the auxiliary controller receives the relevant signal at the Op_mode input. The desired reactive power value is received at the Q_{ref} input and the actually exchanged reactive power at PCC is sensed and received at the Q_{pcc} input. To operate in voltage regulation mode, again the relevant operating mode signal is received at the Op_mode input of the auxiliary controller. The desired voltage at PCC is received at the V_{ref} input while the sensed or measured voltage at PCC is received at the V_{pcc} input. Of course, the desired voltage may be a range as opposed to being a single value. It should be noted that the auxiliary controller in FIG. 3 operates to provide reactive power support or voltage control support for only a limited amount of time. This predetermined amount of time is received at the Override_time input. The Override signal in conjunction with the Override_time input work to provide a PV_disc signal which disconnects the power generation modules (in this case the photovoltaic modules which generate power) from the inverter and, thus, from the power transmission or distribution network.

The difference between voltage regulation and reactive power compensation modes of operation is explained here. When the power generation facility inverter is used to provide a fixed leading or lagging reactive power to the transmission or distribution network, the voltage at PCC is indirectly raised or lowered, respectively, by a certain percentage. This percentage depends on the amount of reactive power (lagging or leading) supplied and the parameters of the network, such as, system strength, etc. However, there is no direct control over such voltage regulation. On the other hand, during the voltage regulation mode of operation, a dynamically controllable reactive power (leading or lagging) is exchanged with the transmission and distribution network to maintain the voltage at specified value or within a specific range.

It should be noted that the term “system control support” encompasses both reactive power support and voltage control support.

To provide reactive power support or voltage control support to the power transmission or transmission network, the power generation facility generally first receives an indication that reactive power support or voltage control support is required by the network. This may be done by sending a control signal or a communication to the power generation facility from a power transmission/distribution network office or system operator. The communication would, ideally, give an indication as to when support is needed, for how long, and the parameters of the required support. The parameters may include the type of support required (e.g. fixed reactive power support vs. voltage regulation support), the values required (e.g. the desired value for Q_{ref}, or the voltage value V_{ref} or range desired for the voltage at the point of common coupling), and the desired duration of the voltage control support. Of course, some of these parameters may be prearranged and predetermined between the entity operating or owning the power transmission/distribution network and the entity operating or owning the power generation facility.

Once the power generation facility receives this indication that reactive power support or voltage control support is required, the power generation facility disconnects the power generation modules from providing real power to the power transmission/distribution network. Thus, the power generation modules (which may be photovoltaic cells (if the facility is a solar farm), wind activated turbines, or the like) are thus unused while the power generation facility is providing voltage control support. In fact, for this invention, all or at least a portion of the power generation facility's inverter capacity or rating is dedicated to the reactive power support or voltage control support. This may be done regardless of the time of day. The reactive power support or voltage control support may therefore be provided anytime during the day (e.g., noon, early morning or late evening) by the PV solar systems, while the same may be provided over the entire 24-hour period by other inverter based DGs.

Once the power generation modules have been disconnected, the inverter based power generation facility can function as a STATCOM. The utilization of these power generation facilities, such as solar farms and wind farms, as STATCOMs is applicable regardless of the following: 1) type and configuration of inverter e.g., 6 pulse, 12 pulse, multilevel, etc, 2) type of semiconductor switches used is inverters, e.g. GTO, IGBT, etc, 3) type of firing methodology used, PWM, SPWM, hysteresis control, PLL based, etc., 4) methodology of controller design, e.g., pole placement, lead lag control, genetic algorithm based control, fuzzy control, etc, 5) type of control, e.g., continuous, discrete, analog, digital, etc., 5) choice of auxiliary control signals, e.g., local signals, remote signals, such as, phasor measurement unit (PMU) acquired signals, etc.

It should be noted that while the Figures illustrate a photovoltaic solar farm as the power generation facility, other inverter based power generation facilities, such as wind farms, may be used with the invention. As well, it should be noted that banks of capacitors or inductors may be present at the power generation facility. These capacitor or inductor banks may be coupled to the inverter once the power generation modules have been disconnected to provide increased capacity or rating for reactive power support or voltage control support. In one embodiment, a switch matrix may be used to couple differing numbers of capacitors or inductors to the inverter, thereby better adjusting the reactive power or the voltage at the PCC. The capacitor or inductor banks can thus be used to provide coarse control of the amount of reactive power support or voltage control support. Similarly, the continuously controllable inductive or capacitive reactive power provided by the inverter subsystem can be used as the fine control for the amount of reactive power support or voltage control support.

The present invention is typically more beneficial for a large-scale power generation facility. It is preferred that the PV solar farm capacity should be high enough (i.e. in the order of several tens of kilowatts or megawatts) to give satisfactory results. The present invention is equally applicable to smaller size DG systems with the caveat that such implementations would have reduced compensation capability for the power transmission and distribution networks.

All the proposed embodiments and capabilities of the invention can be achieved for any type of power distribution or power transmission network, be it of radial type or meshed type.

While the above discussion adapts a solar farm or wind farm inverter to operate as a STATCOM, the invention is not limited to only wind or solar farms. Any other inverter based DG system that is capable of disconnecting its power generation modules from the inverter, can also be utilized as a STATCOM as described above. For instance, such a DG system could be a large inverter based Fuel Cell based DG.

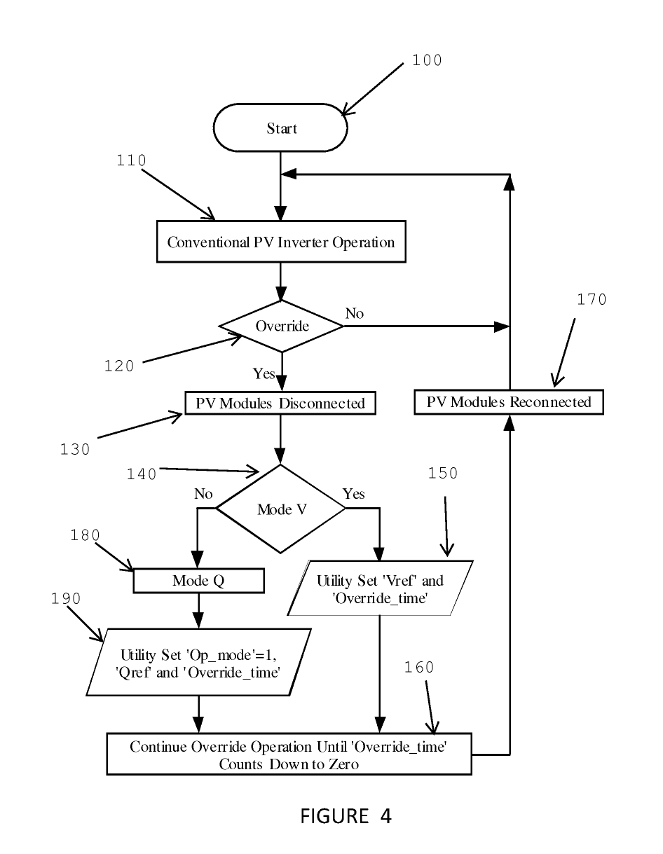

Regarding the operation of the power generation facility and the logic followed by the circuitry illustrated in FIG. 3, the flowchart for the operation is shown in FIG. 4. The process begins with start block 100. The power generation facility initially is operating in its regular power generation mode (step 110). Decision 120 checks if an override signal has been received by checking the override input as shown in FIG. 3. The override signal may come as the indication that voltage control support is needed or it may be initiated after the indication has been received elsewhere, such as at the head office of the entity operating the power generation facility. If there is no override signal detected, then the logic flow returns to the normal operation of the facility (step 110). On the other hand, if an override signal has been detected, the power generation modules (the PV modules in a solar farm implementation) are disconnected from the inverter (step 130). The PV_disc signal in FIG. 3, as noted above, disconnects the PV modules from the inverter. After the disconnection, the operational mode of the inverter is determined (decision 140). Decision 140 determines if the operational mode is that of voltage regulation. If voltage regulation is indicated by the Op_mode signal, then the system determines the desired voltage by checking the V_{ref} signal and also determines how long the override is to last by checking the Override_time signal (step 150). As noted above, these parameters are set by or received from the power transmission or distribution network operators or by the power utility company that needs the voltage control support. These parameters can be sent to the Inverter based generating system by the power system operators.

After the desired voltage and the desired override time have been set and/or sent to the auxiliary controller, the override operation (i.e. the voltage control support) continues until the override time expires (step 160). Once the override time expires, the power generation modules are then reconnected to the inverter (step 170) and the power generation facility returns to its normal operating mode of generating power (step 110).

Returning to decision 140, if the desired operating mode is not that of voltage regulation, the logic flow then moves to step 180. Step 180 is that of setting the operating mode to reactive power support mode (mode Q in FIG. 4). The parameters for the reactive power support mode are then entered into the system or received by the system (step 190). These parameters include the desired reactive power Q_{ref} and the duration of the reactive power support, Override_time. As with the voltage regulation mode, these parameters are set by or received from the operators of the power transmission or distribution network, or by the relevant power utility company. Step 160 is then that of continuing the reactive power support mode operation until the override timer expires. Once this timer has expired, the power generation modules are reconnected to the inverter (step 170) and the power generation facility returns to its regular power generation function (step 110).

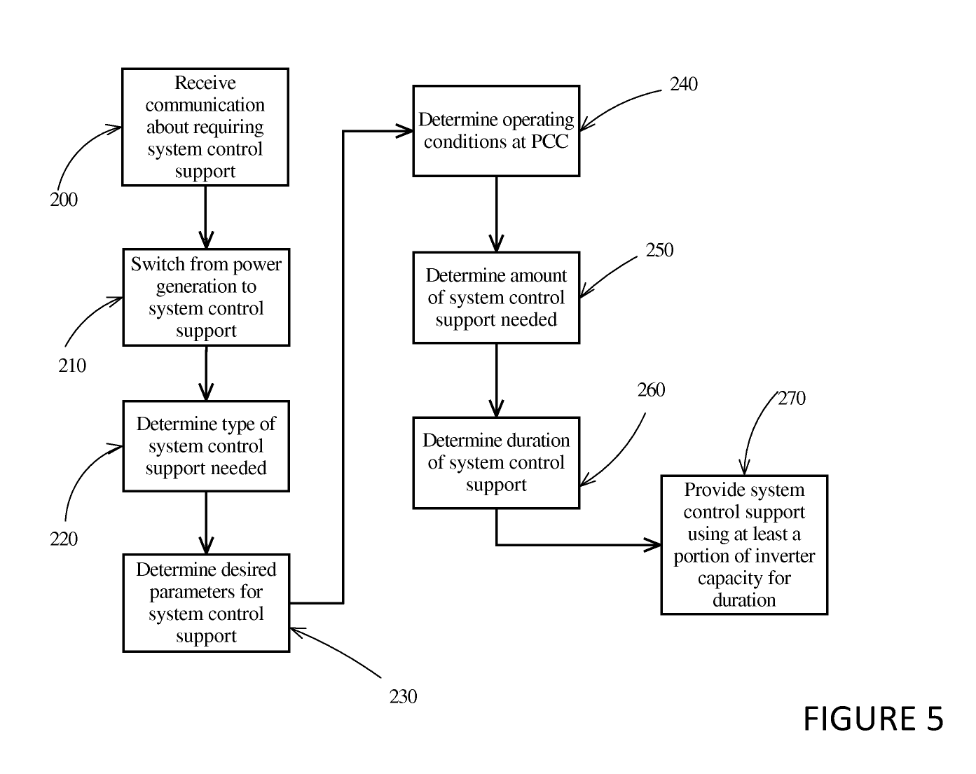

It should be noted that the overall method for one aspect of the invention involves the steps illustrated in FIG. 5. The process begins at step 200, that of receiving a communication noting that the power transmission/distribution network requires system control support which could be in the form of reactive power support or voltage control support. Based on the configuration of the power generation facility, this step can be automatic with the facility receiving a signal from the power transmission/distribution network that switches the operation of the power generation facility into a system control support facility. Alternatively, the step can be manual, with the entity operating the power transmission/distribution network sending a communication to the entity operating the power generation facility requesting that inverter capacity be made available for system control support which could be either reactive power support or voltage control support to the power transmission/distribution network. Once this communication has been received, the power generation facility can switch its function from real power generation to “system control support mode of operation (step 210). This can be done by disconnecting all or a portion of the power generation modules from the inverter as may be needed to make required inverter capacity available for operating the power generation facility as a STATCOM. If the system control support is not large, a portion of the inverter can continue producing real power and the remaining portion is freed up to function as a STATCOM. Step 220 then determines what type of system control support is required. As noted above, the system support may be either reactive power support or voltage regulation/voltage maintenance support. Once the required system support has been established, the parameters for the reactive power support or voltage control support can be determined (step 230). This involves determining the desired reactive power support or the desired voltage or voltage range to be maintained at the point of common coupling. The desired parameters as well as the type of reactive power or voltage control support needed are preferably supplied by the entity controlling the power transmission/distribution network operator or by the power utility company.

After determining the desired parameters, the next step is that of determining the operating conditions at the point of common coupling (step 240). This is executed by reading the Q_{pcc} or the V_{pcc} at the point of common coupling and transmitting those readings to the relevant input lines on the auxiliary controller shown in FIG. 3. The amount of system support (i.e. how much reactive power support is required or what is the value or range of voltage that is required) is then determined (step 250). From the circuit diagram of the auxiliary controller in FIG. 3, it can be seen that this is done by determining the difference between the desired parameter, whether it be reactive power or voltage reference, and the relevant value sensed in step 240. The duration for the reactive power support or voltage control support required can then be determined (step 260). As with the parameters for the reactive power support or voltage control support, this duration can come from the entity operating the power transmission/distribution network or from the power utility company. Once all the parameters have been determined and the inverter is set to operate as a STATCOM, the power generation facility then provides reactive power support or voltage control support for the duration of the desired time period using all or a portion of the inverter capacity of the facility.

It should further be noted that previous attempts at operating solar farms as STATCOMs only contemplated using all or at least a part of the solar farm's inverter capacity for reactive power support or voltage control support and was constrained to providing such support only during nighttime (when the solar farm is completely idle) or during daytime when the solar farm is not producing its rated real power output (e.g., during early morning or late evening hours which are off-peak hours). The real power production of the solar farm was not affected or curtailed. The present invention operates to provide reactive power support or voltage control support regardless of the time of day, by curtailing the real power output of the generating facility for the requested duration of time.

Since the present invention contemplates using the power generation facility's complete inverter capacity or a portion of it for reactive power support or voltage control support in lieu of generating real power, it is quite conceivable that the power generation facility operator could lose money if he or she accedes to the power transmission network operator's request for reactive power support or voltage control support. To address this potential shortcoming, the operator of the power generation facility may charge the entity requiring the reactive power support or voltage control support for the use of the power generation facility's inverter capacity. The amount charged may be based on the amount of reactive power support provided in the form of fixed reactive power or controlled reactive power for voltage control support. Similarly, the amount charged may be based on the amount of time the reactive power support or voltage support was needed as well as the time of day. If the reactive power support or voltage control support was needed during or near peak power generation hours, then the charge per unit may be higher (or significantly higher) than the amount the power that would have been generated would have brought. As an example, if the power that would have been generated was being sold to the power utility company for $0.80 per kW/hr, the amount charged could be $2.00 per kW/hr of reactive power or voltage control support to meet a critical power system need. Of course, it should be clear that the term “charge per unit” is subject to multiple interpretations and may include a per unit time charge, per kVar charge, per kVar-hr charge, or any combination of the above.

From the above, it should be clear that other means and concepts for charging for the reactive power support or voltage control support may be used. As an example, if the reactive power support or voltage control support was needed during what would have been prime (if not peak) power generation times, then the charge would be higher per unit than if the reactive power support or voltage control support was required at other times. Similarly, if the reactive power support or voltage control support was required at prime power consumption times, the charge to the power utility company may be higher per unit. Also, if the reactive power support or voltage control support is required for a critical system emergency, the charges could be significantly higher and may be commensurate with the benefit brought to the transmission/distribution system operator or utility by providing this service.

Referring back to FIG. 3, it should be clear that the auxiliary controller illustrated is not part of the conventional controller. In fact, the auxiliary controller in the figure only has one input (or a very limited number of inputs in large PV systems) to the conventional controller. Because of this, conventional inverter controllers can be easily retrofitted with the auxiliary controller, thereby providing the owners and operators of inverter based power generation facilities with the advantages of the present invention as described above.

It should be clear that the term “power transmission network” or the term “power network” includes the concept of power distribution networks or electrical distribution networks.

A person understanding this invention may now conceive of alternative structures and embodiments or variations of the above all of which are intended to fall within the scope of the invention as defined in the claims that follow.

We claim:

1. A method for providing system control support to a power transmission network using an inverter based power generation facility, the method comprising:
a) determining that system control support is required by said power transmission network;
b) determining power conditions on said power transmission network;
c) determining an amount of reactive power support or voltage control support as part of system control support required, based on said power conditions;
d) altering a function of said power generation facility from real power production to provision of system control support; and
e) utilizing at least a portion of said power generation facility's inverter capacity to provide said system control support.

2. A method according to claim 1 wherein said power generation facility is a photovoltaic based power generation facility.

3. A method according to claim 1 wherein said power generation facility is an inverter based wind farm.

4. A method according to claim 1 wherein said power generation facility couples to said power transmission network at a common coupling point and wherein step b) comprises:
determining an amount of reactive power exchanged at said common coupling point.

5. A method according to claim 1 wherein said power generation facility couples to said power transmission network at a common coupling point and wherein step b) comprises:
determining a voltage on said power transmission network at said common coupling point.

6. A method according to claim 1 wherein said method is executed during power generation hours for said power generation facility.

7. A method according to claim 1 wherein step d) comprises disconnecting at least one power generation module from an inverter at said power generation facility.

8. A method according to claim 4 wherein said reactive power support comprises providing a fixed amount of reactive power support at said common coupling point.

9. A method according to claim 5 wherein said voltage control support comprises providing dynamically controlled reactive power to adjust a voltage at said common coupling point.

10. A method according to claim 1 wherein step e) comprises coupling said power generation facility to a plurality of capacitors to provide said system control support.

11. A method according to claim 1 wherein step e) comprises coupling said power generation facility to a plurality of inductors to provide said system control support.

12. A method according to claim 8 wherein said reactive power support is adjusted based on a desired reactive power.

13. A method according to claim 9 wherein said voltage is adjusted based on a desired voltage range.

14. A method according to claim 1 wherein said system control support comprises reactive power support.

15. A method according to claim 1 wherein said system control support comprises voltage control support.

16. A method of generating income for an inverter based power generation facility, the method comprising:
a) receiving an indication that system control support is required by a power transmission network;
b) altering a function of said power generation facility from real power production to provision of system control support;
c) providing said system control support to said power transmission network for a predetermined amount of time using at least a portion of said power generation facility's inverter capacity;
d) charging an operator of said power transmission network for said provision of system control support to said power transmission network.

17. A method according to claim 16 wherein said operator is charged based on an amount of system control support provided.

18. A method according to claim 16 wherein said operator is charged based on said predetermined amount of time.

19. A method according to claim 16 wherein step b) comprises disconnecting at least one power generation module from said power transmission network.

20. A method according to claim 16 wherein said power generation facility is a photovoltaic based power generation facility.

21. A method according to claim 16 wherein said power generation facility is an inverter based wind farm.

22. A method according to claim 16 wherein said system control support is provided during power generation hours for said power generation facility.

23. A method according to claim 16 wherein said system control support comprises reactive power support and which further comprises providing a fixed reactive power equal to a desired value at said common coupling point.

24. A method according to claim 16 wherein said system control support comprises providing dynamically controlled reactive power to adjust a voltage at said common coupling point.

25. A method according to claim 16 wherein step c) comprises coupling said power generation facility to a plurality of capacitors to provide said system control support.

26. A method according to claim 16 wherein step c) comprises coupling said power generation facility to a plurality of inductors to provide said system control support.

27. A method according to claim 23 wherein said reactive power support is adjusted based on a desired value of reactive power.

27. A method according to claim 24 wherein said voltage is adjusted based on a desired voltage range.

29. A method according to claim 16 wherein said power generation facility utilizes at least a portion of its inverter capacity to provide said system control support.
